(19) United States
(12) Patent Application Publication
(10) Pub. No.: US 2012/0155386 A1
(43) Pub. Date: Jun. 21, 2012

(54) SIGNALING REDUCTION FOR THE CORE NETWORK OF A WIRELESS COMMUNICATIONS SYSTEM

(75) Inventors: Dilip Krishnaswamy, San Diego, CA (US); Samir S. Soliman, San Diego, CA (US); Soumya Das, San Diego, CA (US)

(73) Assignee: QUALCOMM Incorporated, San Diego, CA (US)

(21) Appl. No.: 12/974,948

(22) Filed: Dec. 21, 2010

(51) Int. Cl. H04W 68/02; H04W 36/00; H04W 12/06; H04W 88/08; H04W 72/04

(52) U.S. Cl. 370/328; 455/458; 455/450; 455/411; 455/436

(57) ABSTRACT

Systems, methods, devices, and computer program products are described for the reduction of signaling to the core network of a wireless communications system. In one example, a proxy receives a request message transmitted from a mobile device to the core network. The proxy traps the request message to prevent it from being forwarded to the core network. The proxy generates a request accept message in response to the trapped request message, the request accept message spoofing a core network response to the request message. The proxy transmits the request accept message to the mobile device.

### BACKGROUND

The following relates generally to wireless communication, and more specifically to the reduction of signaling for the core network of a wireless communications system. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and various combinations thereof.

Generally, a wireless multiple-access communications system may include a number of base stations, each simultaneously supporting communication for multiple mobile terminals. Base stations may communicate with mobile terminals on downstream and upstream links. Each base station has a coverage range, which may be referred to as the coverage area of the cell. In cellular deployments, a “macrocell” is used to describe a cell serving a wider region such as rural, suburban, and urban areas. A “femtocell” is a smaller cell, typically deployed for use in a home, small business, building, or other limited region. It often is connected to a service provider's network via a broadband connection. In 3GPP terms, femtocells may be referred to as Home NodeBs (HNB) for UMTS (WCDMA, or High Speed Packet Access (HSPA)) and Home eNodeBs (HeNB) for LTE.

Recently, some wireless service providers have started reporting a significantly higher load in their core networks, even when users are not sending much data. Application-layer signaling and keepalive messages can be used by applications to maintain connectivity and to enable persistence of routing table entries, even when no substantive data is exchanged for the applications on the mobile platform.

By way of example, in 3GPP networks, when a mobile device goes into idle mode, the packet data protocol (“PDP”) context may be deactivated, and this action may propagate signals all the way into the core network (the Gateway GPRS Support Node (“GGSN”) and Serving GPRS Support Node (“SGSN”)). When there is new signaling activity for the device, these PDP contexts are reactivated, resulting in additional signaling to the core network to reactivate the PDP context. Thus, a lot of context signaling may occur because of the repeated deactivation and reactivation for PDP contexts (e.g., for presence updates, texts, other social networking applications). There may, therefore, be a need in the art to integrate or otherwise introduce novel functionality to reduce this signaling.

### SUMMARY

The described features generally relate to signaling in the core network of a wireless communications system. Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

Systems, methods, devices, and computer program products are described for the reduction of signaling in the core network of a wireless communications system. In one example, a NAS proxy (e.g., which may be integrated into a radio network controller (RNC) or an eNodeB) may receive a request message transmitted from a mobile device and destined for the core network. The NAS proxy traps the request message to prevent it from being forwarded to the core network. The NAS proxy generates a request accept message in response to the trapped request message, the request accept message spoofing a core network response to the request message. The NAS proxy transmits the request accept message to the mobile device. A number of other examples will be set forth in detail below.

An exemplary method of message generation may include receiving a request message transmitted from a mobile device and directed at a core network; trapping the request message to prevent the request message from being forwarded to the core network; generating a request accept message in response to the trapped request message, the request accept message spoofing a core network response to the request message; and transmitting the request accept message to the mobile device.

Examples of such a method may include one or more of the following: trapping a core network-initiated message directed at the mobile device, the trapping to prevent the core network-initiated message from being forwarded to the mobile device; and generating a response message to the trapped core network-initiated message, the response message spoofing the mobile device response to the core network-initiated message. The request message may be a context deactivation request message. The request accept message may be a context deactivation accept message. The context may remain active in the core network and deactivated at the mobile device.

Also or alternatively, the method may include receiving a context reactivation request message transmitted from the mobile device; trapping the context reactivation to prevent the context reactivation message from being forwarded to the core network; and generating a context reactivation accept message in response to the trapped context reactivation request message, the context reactivation accept message spoofing a core network response to the context reactivation request message.

The method may also include receiving a message from the core network directed to the mobile device; and trapping the message from the core network to prevent the message from the core network from being forwarded to the mobile device.

The method may also include paging the mobile device to wake up for context reactivation; generating a context reactivation message; transmitting the context reactivation message to the mobile device; and transmitting the message from the core network to the mobile device. The radio access bearers allocated to the mobile device may be taken down when the context is deactivated at the mobile device; and radio access bearers may be set up when the context is reactivated at the mobile device. The request message may be a context reactivation request message; and the request accept message may be a context reactivation accept message. The context may remain active in the core network. The request message may be an authentication message; and the request accept message may be an authentication verification message.

The method may be performed at least in part by a network node comprising a femtocell, an eNodeB, a radio network controller, or a service network gateway. The method may also include performing a handoff from a first base transceiver station served by a first network node to a second base transceiver station served by a second network node; transmitting information related to the handoff to the core network; and transferring a proxy session from the first network node to the second network node. The network node may include the first base transceiver station or second base transceiver station.

The method may also include receiving a plurality of additional control messages directed at the core network transmitted from other mobile devices; trapping and caching the plurality of additional control messages to prevent, at least temporarily, the plurality of additional control messages from being forwarded to the core network; and aggregating the request message and the plurality of additional control messages for transmission to the core network.

The method may also include receiving a plurality of additional control messages directed at the core network transmitted from the mobile device; trapping and caching the plurality of additional control messages to prevent, at least temporarily, the plurality of additional control messages from being forwarded to the core network; and aggregating the request message and the plurality of additional control messages for transmission to the core network.

The method may also include receiving a plurality of data messages directed at the core network transmitted from the mobile device and other mobile devices; trapping and caching the plurality of data messages to prevent, at least temporarily, the plurality of data messages from being forwarded to the core network; and aggregating the plurality of data messages for transmission to the core network, while permanently preventing the request message from the mobile device from being forwarded to the core network. The aggregation of data messages may be performed with respect to data sessions that are equal or similar in terms of quality-of-service requirements.

The method may also include receiving a plurality of data messages directed at the core network transmitted from the mobile device; trapping and caching the plurality of data messages to prevent, at least temporarily, the plurality of data messages from being forwarded to the core network; and aggregating the plurality of additional data messages for transmission to the core network, while permanently preventing the request message from being forwarded to the core network. The aggregation of data messages may be performed with respect to data sessions that are equal or similar in terms of quality-of-service requirements

The method may also include monitoring an amount of core network signaling; identifying when the monitored amount exceeds a threshold; and trapping the request message only when the monitored amount exceeds a threshold; monitoring an amount of core network signaling being initiated by the mobile device; identifying when the monitored amount exceeds a threshold; and trapping the request message only when the monitored amount exceeds a threshold.

The method may be performed by a radio network controller or may be performed by an access service network gateway. The core network may be a Packet Data Network Gateway (PGW) and a Serving Gateway (SGW). The mobile device may be user equipment (UE). The method may be performed by an eNode B or may be performed by a femtocell.

The method may also include performing a handoff from a first base transceiver station to a second base transceiver station; and temporarily withholding signaling related to the handoff from the core network.

An exemplary device for message generation may include means for receiving a request message directed at a core network transmitted from a mobile device; means for trapping the request message to prevent the request message from being forwarded to the core network; means for generating a request accept message in response to the trapped request message; and means for transmitting the request accept message to the mobile device.

An exemplary proxy device for a wireless network may include a receiver module configured to receive a request message directed at a core network transmitted from a mobile device; a capture module, communicatively coupled with the receiver module, and configured to trap the request message to prevent the request message from being forwarded to the core network; a message generation module, communicatively coupled with the capture module, and configured to generate a request accept message spoofing a core network response to the request message; and a transmitter module, communicatively coupled with the message generation module, and configured transmit the request accept message to the mobile device.

The capture module may be further configured to trap a core network-initiated message directed at the mobile device, the trapping to prevent the core network-initiated message from being forwarded to the mobile device. The message generation module may be further configured to generate a response message to the trapped core network-initiated message, the response message spoofing the mobile device response to the core network-initiated message. The request message may be a context deactivation request message; and the request accept message may be a context deactivation accept message. The context may remain active in the core network and deactivated at the mobile device. The receiver module may be further configured to receive a context reactivation request message transmitted from the mobile device. The capture module may be further configured to trap the context reactivation to prevent the context reactivation message from being forwarded to the core network. The message generation module may be further configured to generate a context reactivation accept message in response to the trapped context reactivation request message, the context reactivation accept message spoofing a core network response to the context reactivation request message. The receiver module may be further configured to receive a message from the core network directed to the mobile device; and the capture module may be further configured to trap the message from the core network to prevent the message from the core network from being forwarded to the mobile device.

The proxy device may also include a paging module, communicatively coupled with the capture module, and configured to page the mobile device to wake up for context reactivation. The message generation module may be further configured to generate a context reactivation message in response to the trapped message from the core network. The transmitter module may transmit the context reactivation message to the mobile device and transmit the message from the core network to the mobile device. The radio access bearers allocated to the mobile device may be taken down when the context is deactivated at the mobile device, and radio access bearers may be set up when the context is reactivated at the mobile device. The request message may be a context reactivation request message, and the request accept message may be a context reactivation accept message. The context may remain active in the core network, the request message may be an authentication message, and the request accept message may be an authentication verification message.

The proxy device may also include a handoff module, communicatively coupled with the transmitter module, and configured to perform a handoff from a first base transceiver station to a second base transceiver station, wherein signaling related to the handoff is, at least temporarily, withheld from the core network. The receiver module may be further configured to receive a plurality of additional control messages directed at the core network transmitted from other mobile devices. The capture module may be further configured to trap and cache the plurality of additional control messages to prevent, at least temporarily, the plurality of additional control messages from being forwarded to the core network. The message generation module may be further configured to aggregate the request message and the plurality of additional control messages for transmission to the core network. The receiver module may be further configured to receive a plurality of additional control messages directed at the core network transmitted from the mobile device. The capture module may be further configured to trap and cache the plurality of additional control messages to prevent, at least temporarily, the plurality of additional control messages from being forwarded to the core network. The message generation module may be further configured to aggregate the request message and the plurality of additional control messages for transmission to the core network. The receiver module may be further configured to receive a plurality of data messages directed at the core network transmitted from the mobile device and other mobile devices. The capture module may be further configured to trap and cache the plurality of data messages to prevent, at least temporarily, the plurality of data messages from being forwarded to the core network. The message generation module may be further configured to aggregate the plurality of data messages for transmission to the core network, while permanently preventing the request message from the mobile device from being forwarded to the core network.

The proxy device may also include a monitoring module, communicatively coupled with the capture module, and may be configured to monitor an amount of core network signaling; identify when the monitored amount exceeds a threshold; and control the capture module to trap the request message only when the monitored amount exceeds a threshold.

The proxy device may also include a monitoring module, communicatively coupled with the capture module, and may be configured to monitoring an amount of core network signaling being initiated by the mobile device; identify when the monitored amount exceeds a threshold; and control the capture module to trap the request message only when the monitored amount exceeds a threshold. The proxy device may be a radio network controller or access service network gateway. The core network may be a Packet Data Network Gateway (PGW) and a Serving Gateway (SGW). The mobile device may be user equipment (UE). The method may be performed by an eNodeB. The proxy device may be a femtocell.

An exemplary computer program product may include a computer-readable medium and may include code for trapping a request message directed at a core network transmitted from a mobile device to prevent the request message from being forwarded to the core network; and code for generating a request accept message for transmission to the mobile device in response to the trapped request message, the request accept message spoofing a core network response to the request message.

An exemplary processor may be configured to: receive a request message directed at a core network transmitted from a mobile device; trap the request message to prevent the request message from being forwarded to the core network; generate a request accept message spoofing a core network response to the request message; and transmit the request accept message to the mobile device.

An exemplary signaling system for a wireless network may include a mobile device configured to transmit a request message directed at a core network; and a proxy module, in communication with the mobile device and the core network, and may be configured to: trap the request message to prevent the request message from being forwarded to the core network; generate a request accept message in response to the trapped request message; and transmit the request accept message to the mobile device.

The signaling system may include a core network, in communication with the proxy module, configured to generate a core network-initiated message directed at the mobile device. The proxy module may be configured to trap and cache the core network-initiated message to prevent it from being forwarded to the mobile device; transmit reactivation messages to the mobile device; and transmit the cached the core network-initiated message when the mobile device is reactivated. The proxy module may be a radio network controller or an eNodeB; and the core network may be a Packet Data Network Gateway (PGW) and a Serving Gateway (SGW).

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a wireless communications system including a proxy module for the reduction of signaling in the core network;

FIG. 2 is a block diagram of a wireless communications system;

FIG. 3 is an alternative example of a wireless communications system;

FIG. 4 is a block diagram of a wireless communications system including a proxy module for the reduction of core network signaling;

FIG. 5 is a block diagram of a proxy module;

FIG. 6 is a block diagram of a proxy module with additional functional modules depicted;

FIG. 7 is a block diagram of a mobile device;

FIG. 8 is a block diagram of a wireless communications system including an integrated proxy module for the reduction of core network signaling;

FIG. 9A is a flowchart of a method for reducing signaling in the core network of a wireless communications system;

FIG. 9B is a flowchart of an alternative method for reducing signaling in the core network of a wireless communications system;

FIG. 10 is a flowchart of a method for reducing context signaling in the core network of a wireless communications system;

FIG. 11 is a flowchart of a method for reducing authentication signaling in the core network of a wireless communications system; and

FIG. 12 is a flowchart of a method for reducing signaling by aggregating messages to the core network of a wireless communications system.

### DETAILED DESCRIPTION OF THE INVENTION

Systems, methods, devices, and computer program products are described for the reduction of signaling in the core network of a wireless communications system. In one example, a proxy receives a request message transmitted from a mobile device and destined for the core network. The proxy traps the request message to prevent it from being forwarded to the core network. The proxy generates a request accept message spoofing a core network response to the request message, and transmits a request accept message to the mobile device.

Techniques described herein may be used for various wireless communications systems such as CDMA, TDMA, FDMA, and OFDMA. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

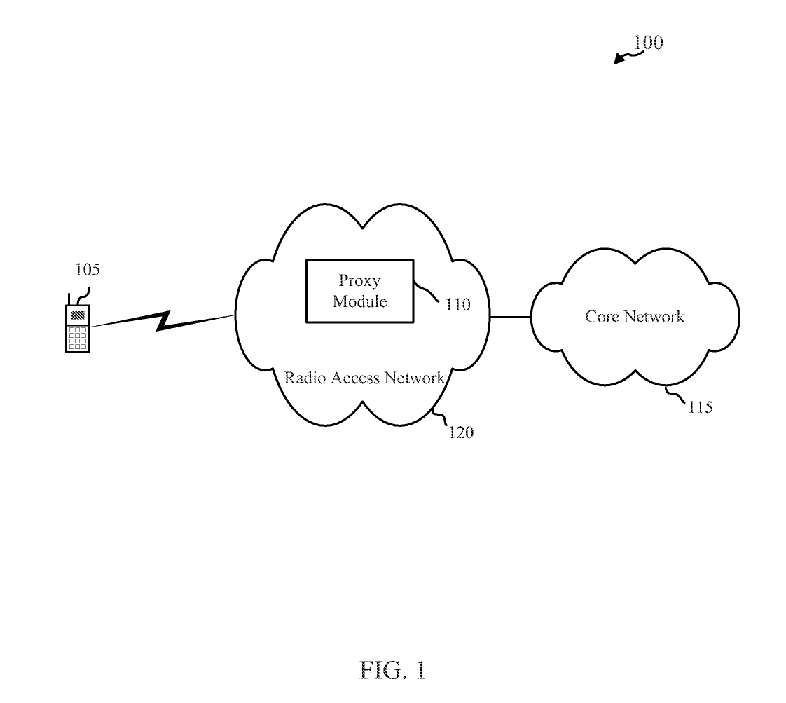

Referring first to FIG. 1, a block diagram illustrates an example of a wireless communications system 100. The system 100 includes a mobile device 105, a proxy module 110 in a radio access network 120, and a core network 115. Each of these components may be in communication with each other, directly or indirectly. At least a portion of the connection between the mobile device 105 and the proxy module 110 may be wireless.

The mobile device 105 may transmit a request message directed at a core network 115. The proxy module 110 may trap the request message to prevent it from being forwarded to the core network 115, and may generate a request accept message in response to the trapped request message. The proxy module 110 may transmit the request accept message to the mobile device 105. The request message may be a context deactivation message, a context reactivation message, an authentication message, a handoff message, or any number of different messages. There is much signaling that may be shielded from the core network 115, including packet data protocol (PDP) context activation, PDP context deactivation, PDP context reactivation, UE initiated service request, CN bearer allocation, and CN bearer clearing messages.

In one example, the request message is a context deactivation request message transmitted from the mobile device 105. The proxy module 110 traps the context deactivation request message to prevent it from being forwarded to the core network 115, and generates a context deactivation request accept message. The core network 115 may be shielded from the signaling, and thus continue to assume that the context remains active at the mobile device 105. Thus, the context may remain active in the core network 115 and deactivated at the mobile device 105. More specifically, the proxy module 110 may keep the core network bearers active, thereby keeping the PDP context active with respect to the core network 115.

In one example, the request message is a context reactivation request message transmitted from the mobile device 105. The proxy module 110 may receive the context reactivation request message, and trap the context reactivation to prevent it from being forwarded to the core network 115. The proxy module may generate a context reactivation accept message in response to the trapped context reactivation request message, the context reactivation accept message spoofing a core network response to the context reactivation request message.

Conversely, the core network 115 may generate a core network-initiated message directed at the mobile device 105. In one example, the proxy module 110 may trap the core network-initiated message to prevent the core network-initiated message from being forwarded to the mobile device, and may generate a response message to the core network-initiated message spoofing a mobile device response.

In another example, assume that the context remains active in the core network 115 and deactivated at the mobile device 105. The proxy module 110 may trap and cache a core network-initiated message to prevent it from being forwarded to the mobile device 105. The proxy module 110 may transmit reactivation messages to the mobile device 105, and transmit the cached the core network-initiated message when the mobile device 105 is reactivated. A number of other examples of proxy module 110 functionality will be described in more detail below.

A proxy module 110 may be a stand alone device located at or near a border between the wireless access network and the core network. In some examples, the proxy module may be integrated into a base transceiver station or femtocell. The proxy module 110 may be integrated with a radio network controller (RNC), a NodeB, an eNodeB, a home nodeB, or home eNodeB. The core network 115 may, for example, be a Gateway GPRS Support Node (GGSN) and/or a Serving GPRS Support Node (SGSN) in a 3GPP system. The core network 115 may, for example, be PDN Gateway (PGW) and a Serving Gateway (SGW) in LTE. A mobile device 105 may be a cellular phone or other wireless communications device, a personal digital assistant (PDA), netbook, tablet computer, laptop computer, etc. A mobile device 105 may be a mobile station, access terminal (AT), user equipment (UE), or subscriber unit.

A wireless connection on some portion of the link between a mobile device 105 and the proxy module 110 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a SC-FDMA signal, etc. Each modulated signal may be sent on a different carrier and may carry control information (e.g., pilot signals), overhead information, data, etc. The system 100 may be a multi-carrier LTE network.

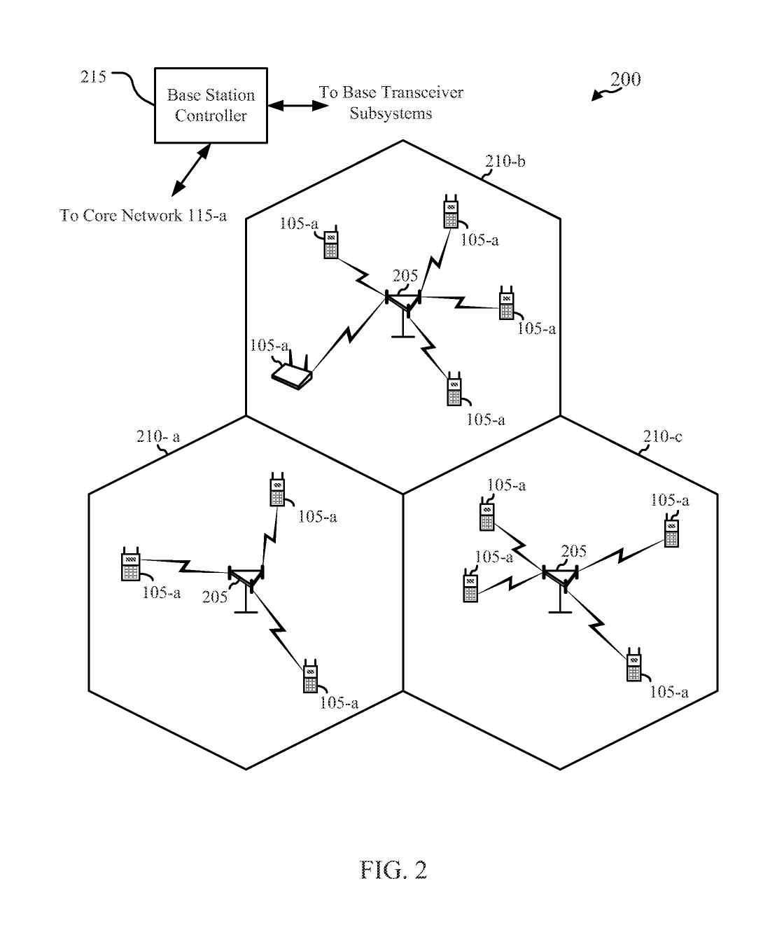

Referring next to FIG. 2, a block diagram illustrates an example of a wireless communications system 200. The system 200 may be an example of the system 100 described with reference to FIG. 1. The system 200 includes base transceiver stations (BTSs) 205, disposed in cells 210, mobile devices 105-a, and a base station controller (BSC) 215. The system 200 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a SC-FDMA signal, etc. Each modulated signal may be sent on a different carrier and may carry control information (e.g., pilot signals), overhead information, data, etc.

The BTSs 205 may wirelessly communicate with the mobile devices 105-a via a base station antenna. The BTSs 205 are configured to communicate with the mobile devices 105-a under the control of the BSC 215 via multiple carriers. Each of the BTSs 205 can provide communication coverage for a respective geographic area, here the cell 210-a, 210-b, or 210-c. The system 200 may include BTSs 205 of different types (e.g., macro, micro, pico, or femto base stations). The mobile devices 105-a may be dispersed throughout the cells 210. A proxy module (e.g., proxy module 110 of FIG. 1) may be integrated into a BTS 205 and/or BSC 215. Thus, with an integrated proxy module, a BTS 205 and/or BSC 215 may trap messages being sent from a mobile device 105-a to the core network 115-a (and vice versa) to prevent certain signaling. A BTS 205 and/or BSC 215 may generate messages to spoof a response, as well. The system 200 may be a multi-carrier LTE system, wherein the BTS 205 represents an eNodeB. The system 200 may be a multi-carrier LTE system, wherein the BTS 205 represents a NodeB and the BSC 215 represents a radio network controller (RNC). The system 200 may be a CDMA 1X system or WiMax system, as well.

A mobile device 105-a may operate on (be “camped” on) a macrocell or similar network facilitated by the BTSs 205. Each macrocell may cover a relatively large geographic area (e.g., several kilometers in radius) and may allow unrestricted access by terminals with service subscription. In addition, the principles described herein may be applied to micro, pico, or femto cells, as well.

A mobile device 105-a may generally operate using an internal power supply, such as a small battery, to facilitate highly mobile operation. Strategic deployment of smaller BTSs 205, such as femtocells, may be used to mitigate mobile device 105-a power consumption. A femtocell may be utilized to provide service within areas which might not otherwise experience adequate or even any service (e.g., due to capacity limitations, bandwidth limitations, signal fading, signal shadowing, etc.), thereby allowing mobile devices 105 to reduce searching times, to reduce transmit power, to reduce transmit times, etc. A femtocell may provide service within a relatively small service area (e.g., within a house or building). Accordingly, a mobile device 105-a is typically disposed near a femtocell when being served, often allowing the mobile device 105 to communicate with reduced transmission power.

By way of example, the femtocell may be a Home NodeB (HNB), Home eNodeBs (HeNB), or Femtocell Access Point (FAP) located in a user premises, such as a residence, an office building, etc. The femtocell location within a building may be chosen for maximum coverage (e.g., in a centralized location), to allow access to a global positioning satellite (GPS) signal (e.g., near a window), or in other locations. Some or all of the functionality of a proxy module (e.g., the proxy module 110 of FIG. 1) may be integrated into a femtocell.

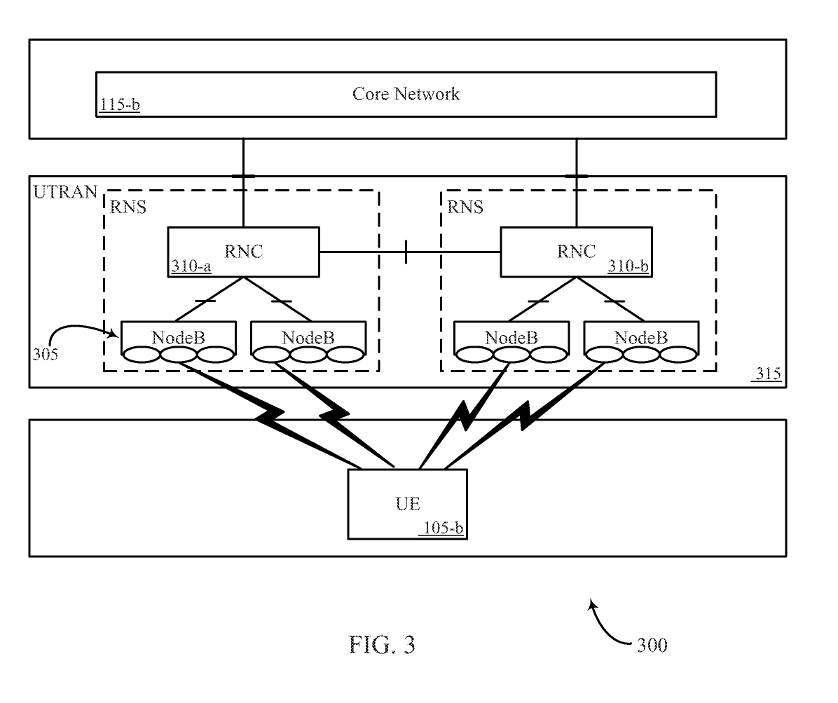

Referring next to FIG. 3, a block diagram illustrates an example of a wireless communications system 300. The system 300 may be an example of the system 100, 200 described with reference to FIG. 1 or 2. NodeBs 305 and radio network controllers (RNCs) 310 are parts of wireless communications system 300. In the illustrated example, the system includes a UMTS Terrestrial Radio Access Network (UTRAN) 315. A UTRAN 315 is a collective term for the NodeBs 105 (or base stations) and the control equipment for the NodeBs 105 (or RNC 120) it contains which make up the UMTS radio access network. This is a 3 G communications network which can carry both real-time circuit switched and IP-based packet-switched traffic types. The UTRAN 315 provides an air interface access method for the user equipment (UE) 105-b. Connectivity is provided between the UE 105-b and the core network 115-b by the UTRAN 315. The UTRAN 315 may transport data packets to multiple UEs 105-b.

The UTRAN 315 is connected internally or externally to other functional entities by a number of interfaces. The UTRAN 315 may be in communication with a core network 115-b via external interface supported by RNCs 310. In addition, the RNCs 310 manage a set of base stations called NodeBs 305. RNCs 310 may be in communication with each other, as well. The UTRAN 315 is largely autonomous from the core network 115-b because the RNCs 310 are interconnected. The NodeBs 305 are in wireless communication with the UE 105-b. The system may be further connected to additional networks (not shown), such as a corporate intranet, the Internet, or a conventional public switched telephone network, and may transport data packets between each UE 105-b and such outside networks.

Each RNC 310 may fill multiple roles. First, it may control the admission of new UEs 105-b or services attempting to use the NodeB 305. Second, from the NodeB 305, or base station, point of view, the RNC 310 is a controlling RNC 310. Controlling admission ensures that UEs 105-b are allocated radio resources (bandwidth and signal/noise ratio) up to what the network has available. An RNC 310 may terminate the UE's 105-b link layer communications.

Proxy module (e.g., proxy module 110 of FIG. 1) functionality may be integrated into a NodeB 305 and/or RNC 310. Thus, with an integrated proxy module, a NodeB 305 and/or RNC 310 may trap messages being sent from a UE 105-b to the core network 115-b to prevent certain signaling from reaching the core network 115-b. A NodeB 305 and/or RNC 310 may generate messages to spoof a response, as well. A NodeB 305 and/or RNC 310 may trap messages being sent from the core network 115-b to a UE 105-b, as well.

For an air interface, UMTS often uses a wideband spread-spectrum mobile air interface known as Wideband Code Division Multiple Access (or W-CDMA). W-CDMA uses a direct sequence code division multiple access signaling method (or CDMA) to separate users. W-CDMA is a third generation standard for mobile communications. W-CDMA evolved from GSM (Global System for Mobile Communications)/GPRS a second generation standard, which is oriented to voice communications with limited data capability. The first commercial deployments of W-CDMA are based on a version of the standards called W-CDMA Release 99.

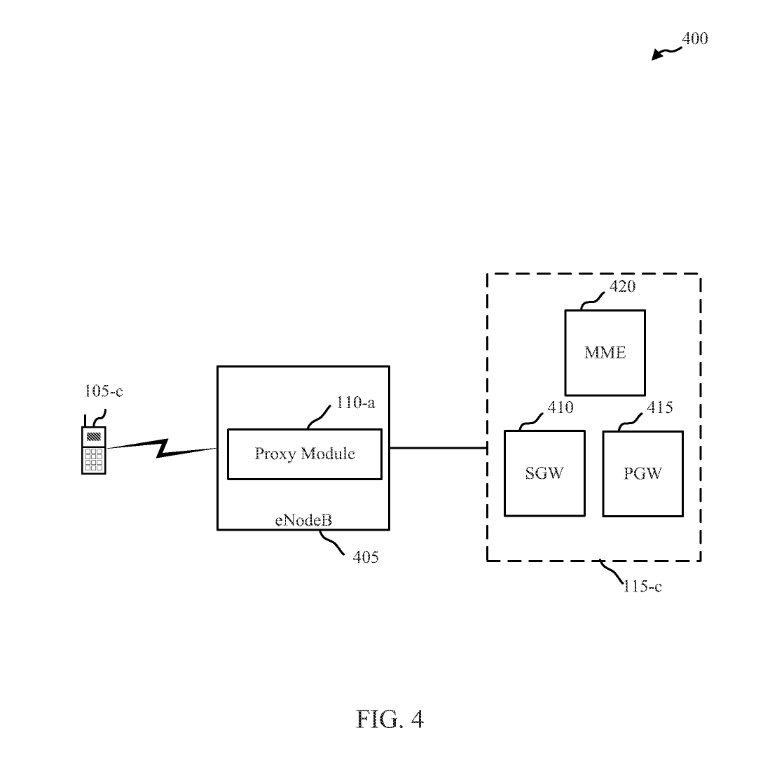

Referring next to FIG. 4, a block diagram illustrates an example of a wireless communications system 400. The system 400 includes a UE 105-c, an eNodeB 405, and a core network 115-c. The eNodeB 405 includes an integrated proxy module 110-a, while the core network 115-c includes a mobility management entity (MME) 420, a serving gateway (SGW) 410, and a packet data network gateway (PGW) 415. Each of these devices may be in communication with each other, directly or indirectly. UE 105-c may be an example of the mobile device 105 of FIG. 1, proxy module 110-a may be an example of the proxy module 110 of FIG. 1, while the core network 115-c may be an example of the core network 115 of FIG. 1. The system 400 architecture is for LTE (e.g., EUTRAN and EPC). Of course, aimilar architecture is possible for UMTS with the proxy module being part of RNC, as depicted in other figures.

The UE 105-c may transmit a message (e.g., a context deactivation message, a context reactivation message, an authentication message, or a handoff message) via a wireless signal, the message destined for the core network 115-c. The eNodeB 405 may receive and process the wireless signal, and the proxy module 110-a may trap the message to prevent it from being forwarded to the core network 115-c. The proxy module 110-a may generate a responsive message (spoofing a response from the core network 115-c). The eNodeB 405 may transmit the responsive message to the UE 105-c. The proxy module 110-a may thereby prevent certain signaling from reaching the core network 115-c.

The core network 115-c may generate a core network-initiated message directed at the UE 105-c. The proxy module 110-a may trap the core network-initiated message to prevent the core network-initiated message from being forwarded by the eNodeB 405 to the UE 105-c. The proxy module 110-a may generate messages (e.g., directed to the core network 115-c or the UE 105-c) related to the core network-initiated message.

The MME 420 is the main control element in the LTE's evolved packet core, handing the control plane interactions in the network. The SGW 410 primarily serves the user plane aspects carrying userplane traffic within the network and it is involved in the control plane as well to carry QoS signaling and other parameters between the MME and the PGW 415. The PGW 415 routes traffic between the core network and external packet data networks and it is the gateway to the internet for the system. It allocates the IP address for a packet data session, and sets up bearers for a packet data session. EPS (Evolved Packet System) core network bearers are set up to carry user plane traffic between the eNodeB and the core network. The proxy node in the eNodeB intercepts core network functions for the control and user plane traffic interactions with the MME 420, the SGW 410 and the PGW 415.

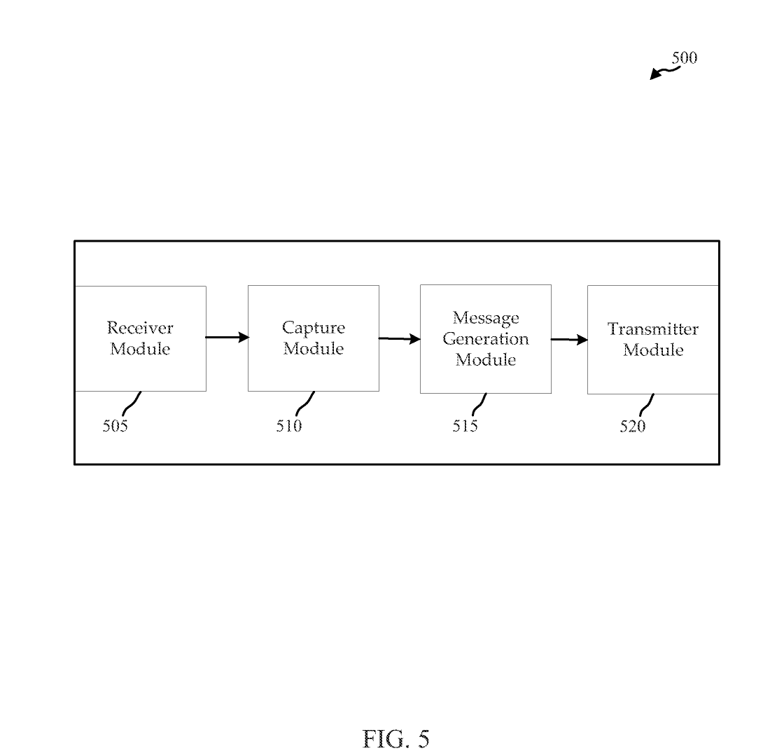

Turning next to FIG. 5, a block diagram illustrates a proxy device 500 which includes proxy module functionality. The device 500 may be the proxy module 110 described with reference to FIG. 1, or may be a device integrating the proxy module functionality (e.g., as described with reference to FIGS. 2-4). The device 500 may also be a processor. The device 500 includes a receiver module 505, capture module 510, message generation module 515, and transmitter module 520. Each of these components may be in communication with each other.

These components of the device 500 may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 505 may receive a request message (e.g., a context deactivation message, a context reactivation message, an authentication message, or a handoff message) directed at a core network transmitted from a mobile device. The capture module 510 may trap the request message to prevent the request message from being forwarded to the core network. The message generation module 515 may generate a request accept message spoofing a core network response to the request message. The transmitter module 520 may transmit the request accept message to the mobile device.

A receiver module 505 may receive a core network-initiated message destined for a mobile device. The capture module 510 may trap the core network-initiated message to prevent (temporarily or permanently) the request message from being forwarded to the mobile device. The message generation module 515 may generate a message related to the core network-initiated message for either the core network or mobile device. The transmitter module 520 may transmit the generated message.

In one example, a UE sends a deactivate PDP context request destined for a SGSN. The receiver module 505 at the proxy device 500 receives the deactivate PDP context request, and the capture module 510 traps the request and does not forward it to the SGSN. The message generation module 515 generates a deactivate PDP context accept message, and the transmitter module 520 sends the message to the UE. The message generation module 515 generates a message (to be sent by the transmitter module 520) for the RNC to tear down the radio bearers. There may also be an inactivity timer, and the message generation module 515 may generate a deactivate PDP context message (to be sent by the transmitter module 520) for the core network once the timer expires.

If UE reactivation occurs before the inactivity timer at the proxy device expires, the UE may request a PDP context reactivation in a message directed to the SGSN. The receiver module 505 at the proxy device 500 receives the reactivate PDP context request, and the capture module 510 traps the request and does not forward it to the SGSN. The message generation module 515 generates a reactivate PDP context accept message, and the transmitter module 520 sends the message to the UE. The message generation module 515 generates a message (to be sent by the transmitter module 520) for the RNC to set up the radio bearers.

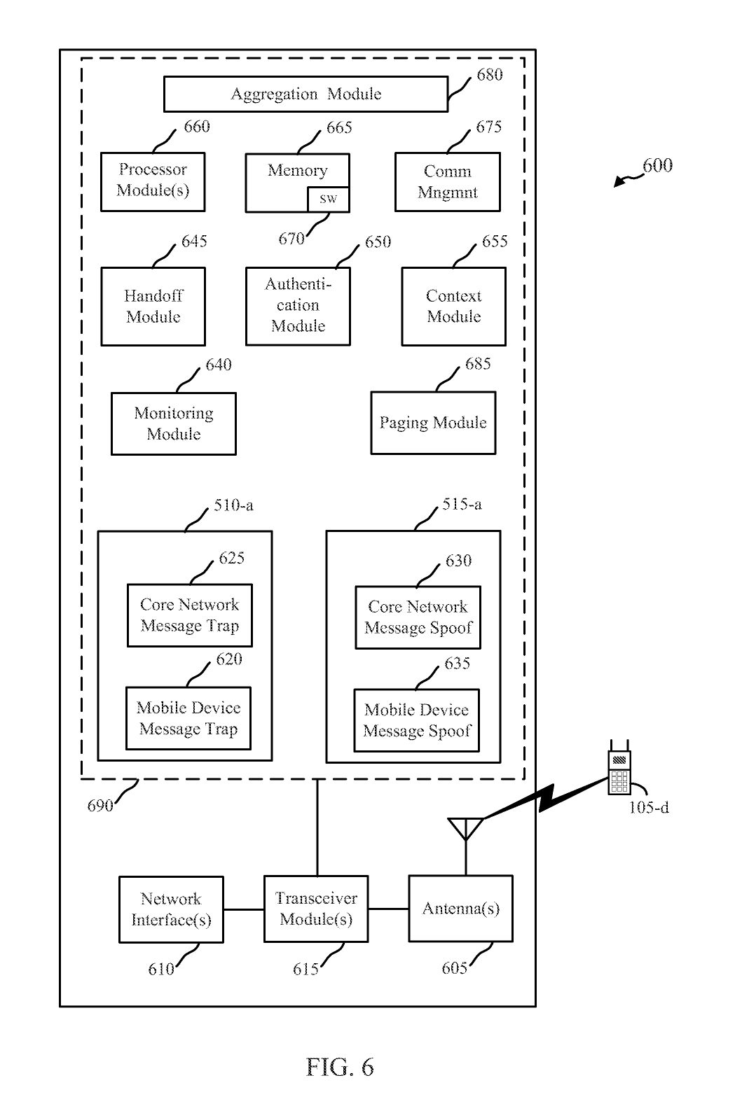

Turning next to FIG. 6, a block diagram illustrates a proxy system 600 which includes proxy module functionality. The system 600 may be an example of the proxy module 110 described with reference to FIG. 1 or the proxy device 500 of FIG. 5, or may be a device integrating the proxy module functionality (e.g., as described with reference to FIGS. 2-4). The proxy system 600 includes wireless (antenna(s) 605) and wired (network interface(s) 610) connectivity, and one or more transceiver module(s) 615. These communications components may be communicatively coupled with any subset of the following components 690: a capture module 510-a (which includes a mobile device message trap 620 and a core network message trap 625), message generation module 515-a (which includes a mobile device message spoof 635 and a core network message spoof 630), monitoring module 640, paging module 685, handoff module 645, authentication module 650, context module 655, aggregation module 680, processor module(s) 660, memory 665 (software 670), and a communication management module 675.

These components 690 of the proxy system 600 may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The capture module 510-a may trap a request message received from mobile device 105-d (using mobile device message trap 620), and thereby prevent the request message from being forwarded to the core network. There are a variety of different types of request messages that may be trapped.

For example, context module 655 may control which types of context activation and deactivation messages may be trapped. The context module 655 may control the mobile device message trap 620 to trap context deactivation request messages transmitted from the mobile device 105-d, to prevent it from being forwarded to the core network. The context module 655 may control the core network message spoof 630 to generate a context deactivation request accept message. The core network may be shielded from the signaling, and thus continue to assume that the context remains active at the mobile device 105-d. While the context remains active at the core network, radio access bearers allocated to the mobile device 105-d may be taken down when the context is deactivated at the mobile device 105-d, and set up when the context is reactivated at the mobile device 105-d.

The request message may also be a context reactivation request message transmitted from the mobile device 105-d. The context module 655 may control the mobile device message trap 620 to trap context reactivation request messages transmitted from the mobile device 105-d, to prevent it from being forwarded to the core network. The context module 655 may control the core network message spoof 630 to generate a context reactivation request accept message, the context reactivation accept message spoofing a core network response to the context reactivation request message.

The capture module 510-a may trap messages received from the core network. The context module 655 may control the core network message trap 625 to trap (and perhaps cache) messages transmitted from core network destined for the mobile device 105-d, to prevent the message from the core network from being forwarded to the mobile device 105-d (either temporarily or permanently). In one example, assume that the context remains active in the core network 115 and deactivated at the mobile device 105. The paging module 685 may page the mobile device 105-d to wake up for context reactivation (and perhaps control an RNC to set up radio access bearers). The context module 655 may control the core network message spoof 630 to generate a context reactivation message for transmission to the mobile device 105-d. The transceiver module 615 may transmit the context reactivation message to the mobile device 105-d, and transmit the cached message from the core network to the mobile device 105-d. In other examples, the context module 655 may control the mobile device message spoof 630 to spoof mobile device 105-d messages.

As referenced above, the capture module 510-a may trap other types of request messages received from mobile device 105-d (using mobile device message trap 620), and thereby prevent certain request messages from being forwarded to the core network. There are a variety of different types of request messages that may be trapped. For example, authentication module 650 may control which types of authentication messages may be trapped. Authentication module 650 may store authentication information instead of the core network. Core network message spoof 630 may use the stored authentication information to spoof an authentication verification message from the core. Handoff module 645 may control which types of handoff messages may be trapped (e.g., handoff messages from a mobile device 105-d, an RNC, or an eNodeB). Handoff module 645 may store base station information instead of the core network. Core network message spoof 630 may use the stored authentication information to spoof a handoff confirmation message from the core. By way of example, assume that there is a handoff from a first NodeB to a second NodeB, each NodeB served by the same RNC with an integrated proxy system 600. The RNC may, at least temporarily, withhold information about the handoff from the core network (because the same RNC manages both NodeBs).

Proxy system 600 may also serve a number of aggregation functions. Control messages directed at the core network may be received from a number of devices (e.g., the mobile devices 105 of FIG. 1). The aggregation module 680 may control the mobile device message trap 620 to trap and cache the control messages. The aggregation module 680 may do this to prevent, at least temporarily, control messages from being forwarded to the core network. The aggregation module 680 may direct the message generation module 515-a to aggregate control messages for transmission to the core network (e.g., via a tunnel). The aggregation module 680 may direct the mobile device message trap 620 to trap and cache control messages for one mobile device 105-d, or a set of mobile devices. Thus, the aggregation module 680 may direct the message generation module 515-a to aggregate control messages for transmission for one mobile device 105-d, or a set of mobile devices.

Data messages directed at the core network may be received from a number of devices (e.g., the mobile devices 105 of FIG. 1). The aggregation module 680 may control the mobile device message trap 620 to trap and cache the data messages. The aggregation module 680 may do this to temporarily prevent data messages from being forwarded to the core network. The aggregation module 680 may control the message generation module 515-a to aggregate data messages for transmission to the core network (e.g., via a tunnel). The aggregation module 680 may control the mobile device message trap 620 to trap and cache data messages for one mobile device 105-d, or a set of mobile devices. The aggregation module 680 may control the message generation module 515-a to aggregate data messages for transmission for one mobile device 105-d, or a set of mobile devices. The aggregation module 680 may therefore orchestrate aggregation on the data plane, the control plane, or a combination thereof; moreover, the aggregation can occur for one mobile device 105-d, or a set of mobile devices. The aggregation module 680 may also route the aggregated messages away from high traffic or congested areas (e.g., in conjunction with the monitoring module 640. Packet data sessions on one device or multiple devices 105-d can be of different priority levels or can have different quality-of-service requirements such as bandwidth and delay. The aggregation module 680 can selectively aggregate data for those data sessions that is equal or similar in terms of priority levels or quality-of-service requirements.

In one example, the aggregation module 680 may control the communication management module 675 to keep a single core network bearer alive for multiple packet data protocol (PDP) contexts that are similar. These multiple contexts may exist for one mobile device 105-d (for different applications). Alternatively these contexts may belong to multiple mobile devices 105 belonging to the same user (all part of the same subscription—such as different m2m devices belonging to a family). Alternatively they could belong to multiple mobile devices 105 belonging to different users, and the same core network bearer may carry information for different contexts. Thus, in one example implementation, the system 600 may share the same core network bearer for radio access bearers for different mobile devices 105 without tearing down the core network bearer.

The aggregation module 680 may aggregate data from different PDP contexts or different apps for the same mobile device 105 or different mobile devices 105 based on the delay tolerance of the data. As soon as the delay tolerance is exceeded for currently residing buffered data at the proxy system 600, then a buffer (e.g., in memory 665) can be flushed and sent to the core network for the uplink. On the downlink, different data for the same mobile device 105 arriving from the core network can be buffered (e.g., in memory 665), and delivered in a burst using one radio access bearer.

The proxy system 600 may also be configured to have the capture module 510-a and message generation module 515-a function only in certain periods of time. For example, monitoring module 640 may be configured to monitor an amount of core network signaling being initiated by the mobile device 105-d. The monitoring module 640 may identify when the monitored signaling exceeds a threshold (e.g., a rate or number of context deactivations/reactivations in a certain time period). The monitoring module 640 may control the capture module 510-a to trap the messages only when the monitored amount exceeds a threshold. The monitoring module 640 may also monitor the traffic or signaling load on the core network, and control the capture module 510-a to trap the messages only when the traffic load or signaling exceeds a threshold. The monitoring module 640 may also monitor the traffic load at the core network, and control aspects of routing, as well.

The components and functionality of the proxy system 600 may be integrated into a single device, or be made up of a number of networked devices (i.e., a number of different devices in communication with each other, directly or indirectly, providing the functionality of the proxy system 600). The transceiver module 615 is configured to communicate bi-directionally, via the antenna(s) 605, with a mobile device 105-d. The transceiver module 615 is also configured to communicate bi-directionally with the core network (and, perhaps, other networks) via network interface(s) 610. For example, network interface(s) 610 may include one or more backend network interfaces (e.g., a backhaul interface providing communication via the Internet, a packet switched network, a switched network, a radio network, a control network, a wired link, and/or the like) for communicating with various devices or other networks.

The memory 665 may include random access memory (RAM) and read-only memory (ROM). The memory 665 may store computer-readable, computer-executable software code 670 containing instructions that are configured to, when executed, cause the processor module 660 (or other components 680) to perform various functions described herein (e.g., call processing, database management, message routing, etc.). Alternatively, the software 670 may not be directly executable but be configured to cause the computer, e.g., when compiled and executed, to perform functions described herein. The processor module 660 may include an intelligent hardware device, e.g., a central processing unit (CPU) such as those made by Intel® Corporation or AMD®, a microcontroller, an application specific integrated circuit (ASIC), etc.

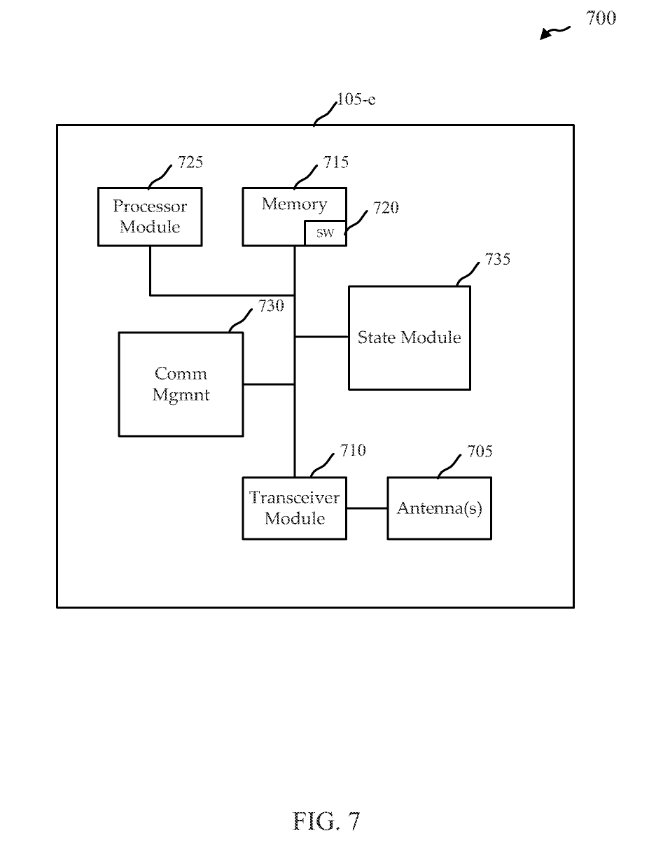

As described above, proxy modules, devices, and systems may be configured to communicate with client devices, such as the mobile device 105 of FIGS. 1-4 and 6. FIG. 7 is a block diagram 700 of a mobile device 105-e. The mobile device 105-e may have any number of different configurations, such as personal computers (e.g., laptop computers, netbook computers, tablet computers, etc.), cellular telephones, PDAs, digital video recorders (DVRs), internet appliances, gaming consoles, e-readers, etc. The mobile device 105-e may have a mobile configuration, having an internal power supply (not shown), such as a small battery, to facilitate mobile operation.

The mobile device 105-e includes antenna(s) 705, a transceiver module 710, memory 715, and a processor module 725, which each may be in communication, directly or indirectly, with each other (e.g., via one or more buses). The transceiver module 710 is configured to communicate bi-directionally, via the antennas 705 over one or more wireless links, with one or more networks, as described above. For example, the transceiver module 710 may be configured to communicate bi-directionally with the proxy module 110 of FIG. 1 or 4, the proxy device 500 of FIG. 5, or the proxy system 600 of FIG. 6.

The memory 715 may include random access memory (RAM) and read-only memory (ROM). The memory 715 may store computer-readable, computer-executable software code 720 containing instructions that are configured to, when executed, cause the processor module 725 to perform various functions described herein (e.g., call processing, database management, message routing, etc.). Alternatively, the software 720 may not be directly executable by the processor module 725 but be configured to cause the computer, e.g., when compiled and executed, to perform functions described herein.

The processor module 725 may include an intelligent hardware device, e.g., a central processing unit (CPU) such as those made by Intel® Corporation or AMD®, a microcontroller, an application specific integrated circuit (ASIC), etc. The processor module 725 may include a speech encoder (not shown) configured to receive audio via a microphone, convert the audio into packets (e.g., 30 ms in length) representative of the received audio, provide the audio packets to the transceiver module 710.

According to the architecture of FIG. 7, the mobile device 105-e further includes a communications management subsystem 730. The communications management subsystem 730 may manage communications with a macrocell or femtocell network. The communications management subsystem 730 may be a component of the mobile device 105-e in communication with some or all of the other components of the mobile device 105-e via a bus. Alternatively, functionality of the communications management subsystem 730 may be implemented as a component of the transceiver module 710, as a computer program product, and/or as one or more controller elements of the processor module 725.

The state module 735 may reflect and control the current device state (e.g., context, authentication, base station association, other connectivity issues). The proxy module 110 of FIG. 1 or 4, the proxy device 500 of FIG. 5, or the proxy system 600 of FIG. 6 may trap messages transmitted from the mobile device 105-e to prevent them from being forwarded to the core network. The proxy module 110 of FIG. 1 or 4, the proxy device 500 of FIG. 5, or the proxy system 600 of FIG. 6 may generate responsive messages for the mobile devoice 105-e which spoof responses from the core network.

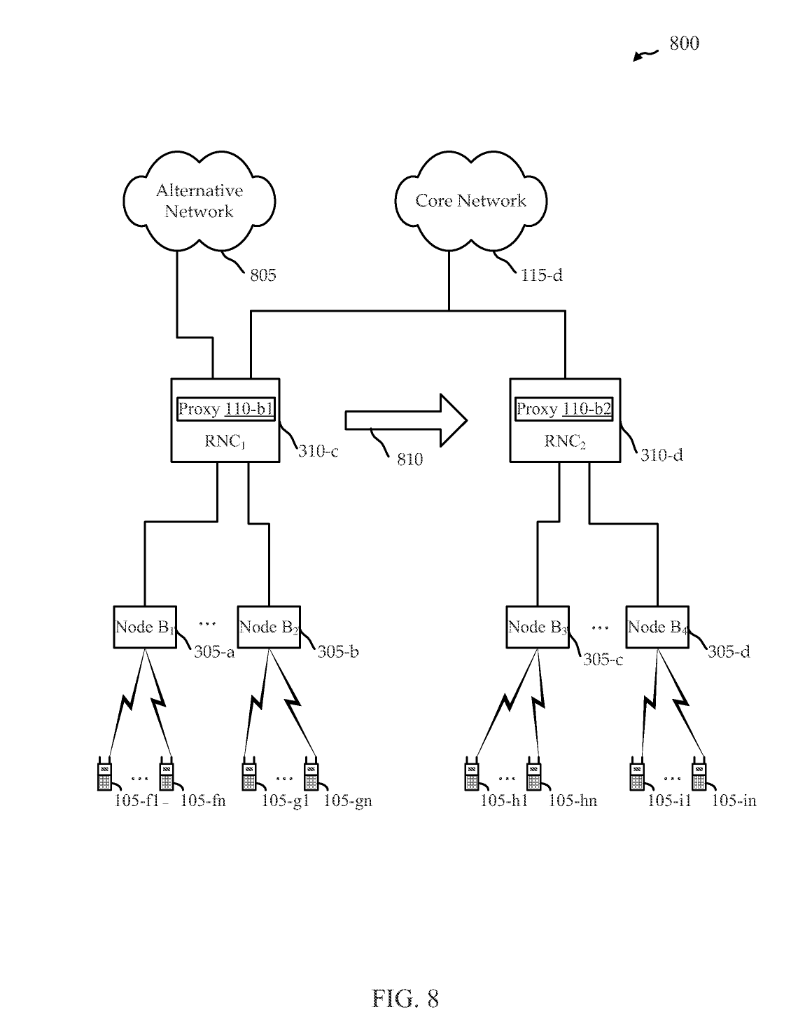

Referring next to FIG. 8, a block diagram illustrates an example of a wireless communications system 800. The system 800 may be an example of the system 100, 200, 300 described with reference to FIG. 1, 2, or 3. The system 800 includes a UEs 105-d, NodeBs 305, RNCs 310, a core network 115-d, and alternative network 805. The RNCs 310 each include a different, integrated proxy module 110-b. Each of the devices in system 800 may be in communication with each other, directly or indirectly. UE 105 may be an example of the mobile device 105 of FIG. 1, 2, 3, or 7, proxy module 110-b may be an example of the proxy module 110 of FIG. 1, proxy device 500 of FIG. 5, or proxy system 600 of FIG. 6, while the core network 115 may be an example of the core network 115 of FIG. 1, 2, or 3.

A UE 105 may transmit a message (e.g., a context deactivation message, a context reactivation message, an authentication message, or a handoff message) via a wireless signal, the message destined for the core network 115-d. A NodeB 405 may receive and forward the message to an RNC 310. A proxy module 110-b may trap the message to prevent it from being forwarded to the core network 115-d. The proxy module 110-b may generate a responsive message (spoofing a response from the core network 115-d). The proxy module 110-b may thereby prevent certain signaling from reaching the core network 115-d. The information about the trapped message and responsive message may be referred to as a “core network proxy session.” A core network proxy session may also, or alternatively, be defined as information about the core network bearers that are maintained, or the radio access bearers that are torn down. The core network proxy session may include any information contained in a deactivation message, reactivation message, handoff message, authentication message, aggregation message, spoofed response message, or other context message. By way of example, the core network proxy session information may include aggregation information on the UEs 105-d, or services of a UE 105-d, being aggregated.

During handoff within different NodeBs of the same RNC (e.g. RNC₁ 310-c that serves multiple NodeBs 305-a-305-b), the core network proxy session for a mobile device may be maintained at the RNC (and signaling regarding the handoff may be shielded (at least temporarily) from the core network 115-d because the RNC manages both NodeBs). During handoff 810 from a NodeB of one RNC 310 to another (e.g., from NodeB₂ 305-b of RNC₁ 310-c to NodeB₄ 305-d of RNC₂ 310-d), the proxy session is migrated 810 to a new RNC 310. Information regarding the handoff may be provided to the core network 115-d (e.g., a Mobility Management Entity (MME) in the core network 115-d). The characteristics of the core network proxy session may be transferred from proxy module 110-b1 at RNC₁ 310-c to proxy module 110-b2 at RNC₂ 310-d. By providing handoff information to the core network 115-d and transferring information on the core network proxy session characteristics, the core network proxy session may functionally be transferred from RNC₁ 310-c to RNC₂ 310-d.

Uplink data transmitted from a UE 105 may be delivered to an alternative network 805 by the proxy module 110-b (e.g., by proxy module 110-b1 at RNC₁ 310-c). For example, IP traffic from a UE 105 may be delivered over an alternative network 805 (bypassing the core network 115-d on which the UE 105 was authenticated). The earlier authentication by the core network 115-d may be utilized to maintain services for the UE 105 over an alternative data path to an alternative network 805.

Aspects of the invention are applicable to Worldwide Interoperability for Microwave Access (WiMAX) standards, as well. For example, the functionality described with reference to the NodeB in FIG. 3 or 8 may be applied to a base station in WiMAX. The functionality described with reference to the RNC 310 of FIG. 3 or 8 may be applied to an access service network gateway (ASN-GW) in WiMAX, and the proxy module 110 of FIG. 1, proxy device 500 of FIG. 5, or proxy system 600 of FIG. 6 may be integrated with or into the ASN-GW. The functionality described with reference to the core network 115 of FIG. 3 or 8 may be applied to the connectivity service network (CSN) in WiMAX.

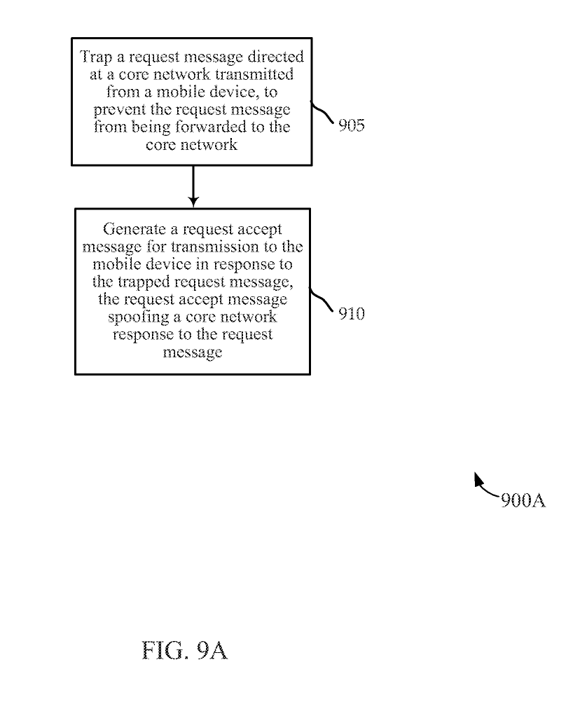

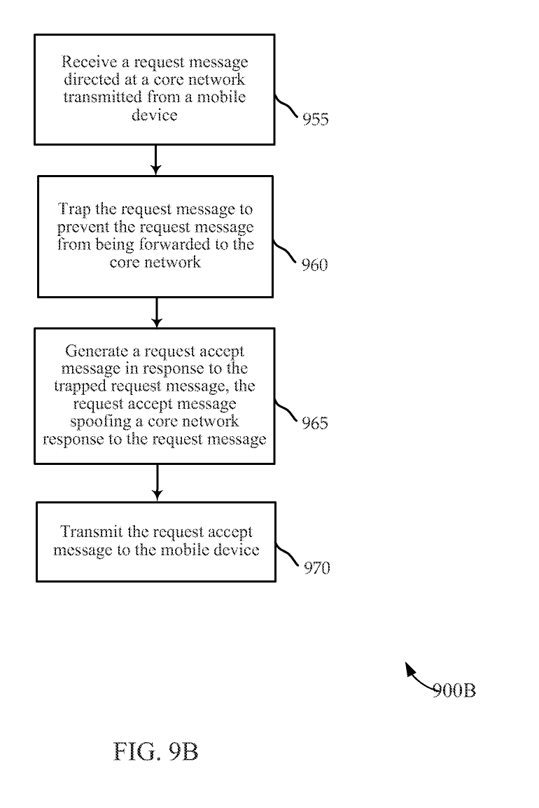

FIG. 9A is a flowchart 900A of a method for reducing signaling in the core network of a wireless communications system according to various embodiments of the invention. The method 900A may be performed, for example, in whole or in part, by the proxy module 110 of FIG. 1 or 4, the proxy device 500 of FIG. 5, or the proxy system 600 of FIG. 6. The method 900A may performed by a BTS 205 or BSC 215 of FIG. 2, a NodeB 305 or RNC 310 of FIG. 3, the eNodeB of FIG. 4, or any combination thereof.

At block 905, a request message transmitted from a mobile device and directed at a core network is trapped to prevent the request message from being forwarded to the core network. At block 910, a request accept message is generated for transmission to the mobile device in response to the trapped request message, the request accept message spoofing a core network response to the request message.

FIG. 9B is a flowchart 900B of an alternative method for reducing signaling in the core network of a wireless communications system according to various embodiments of the invention. The method 900B may be an example of the method 900A of FIG. 9A. The method 900B may be performed, for example, in whole or in part, by the proxy module 110 of FIG. 1 or 4, the proxy device 500 of FIG. 5, or the proxy system 600 of FIG. 6. The method 900B may performed by a BTS 205 or BSC 215 of FIG. 2, a NodeB 305 or RNC 310 of FIG. 3, the eNodeB of FIG. 4, or any combination thereof.

At block 955, a request message is transmitted from a mobile device, and directed at a core network, is received. At block 960, the request message is trapped to prevent the request message from being forwarded to the core network. At block 965, a request accept message is generated in response to the trapped request message, the request accept message spoofing a core network response to the request message. At block 970, the request accept message is transmitted to the mobile device.

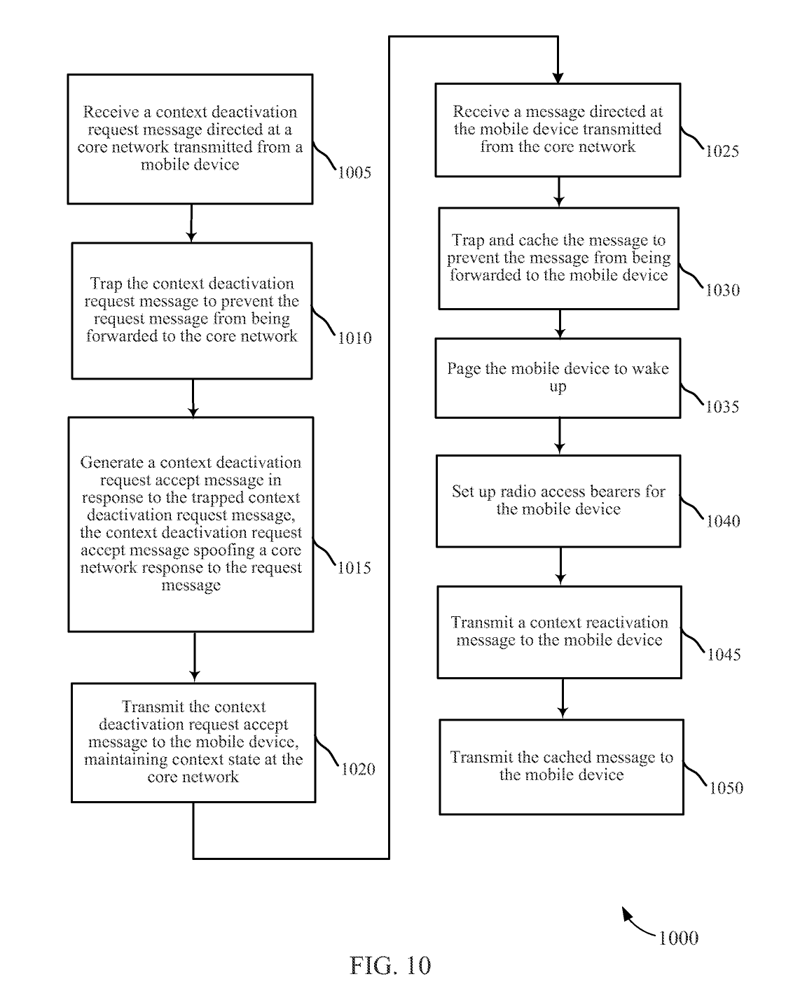

FIG. 10 is a flowchart 1000 of a method for reducing context signaling in the core network of a wireless communications system according to various embodiments of the invention. The method 1000 may be an example of the method 900 of FIG. 9A or method 900B of FIG. 9B. The method 1000 may be performed, for example, in whole or in part, by the proxy module 110 of FIG. 1 or 4, the proxy device 500 of FIG. 5, or the proxy system 600 of FIG. 6. The method 1000 may performed by a BTS 205 or BSC 215 of FIG. 2, a NodeB 305 or RNC 310 of FIG. 3, the eNodeB of FIG. 4, or any combination thereof.

At block 1005, a context deactivation request message is received, the message transmitted from a mobile device and directed at a core network. At block 1010, the context deactivation request message is trapped to prevent the request message from being forwarded to the core network. At block 1015, a context deactivation request accept message is generated in response to the trapped context deactivation request message, the context deactivation request accept message spoofing a core network response to the request message. At block 1020, the context deactivation request accept message is transmitted to the mobile device, maintaining context state at the core network. At block 1025, a message directed at the mobile device transmitted from the core network is received. At block 1030, the message is trapped and cached to prevent the message from being forwarded to the mobile device. At block 1035, the mobile device is paged to wake up. At block 1040, radio access bearers are set up for the mobile device. At block 1045, a context reactivation message is transmitted to the mobile device. At block 1050, the cached message is transmitted to the mobile device.

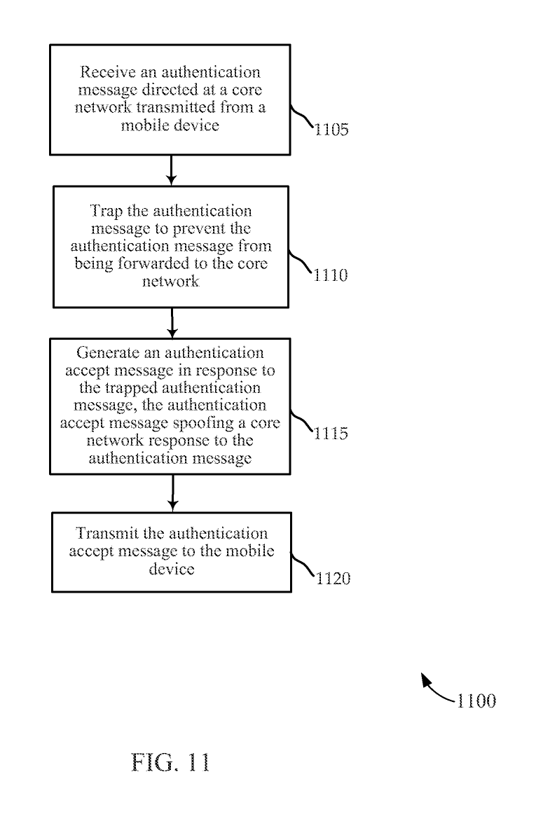

FIG. 11 is a flowchart 1100 of a method for reducing authentication signaling in the core network of a wireless communications system according to various embodiments of the invention. The method 1100 may be an example of the method 900A of FIG. 9A or method 900B of FIG. 9B. The method 1100 may be performed, for example, in whole or in part, by the proxy module 110 of FIG. 1 or 4, the proxy device 500 of FIG. 5, or the proxy system 600 of FIG. 6. The method 1100 may performed by a BTS 205 or BSC 215 of FIG. 2, a NodeB 305 or RNC 310 of FIG. 3, the eNodeB of FIG. 4, or any combination thereof.

At block 1105, an authentication message transmitted from a mobile device directed at a core network is received. At block 1110, the authentication message is trapped to prevent the authentication message from being forwarded to the core network. At block 1115, an authentication accept message is generated in response to the trapped authentication message, the authentication accept message spoofing a core network response to the authentication message. At block 1120, the authentication accept message is transmitted to the mobile device.

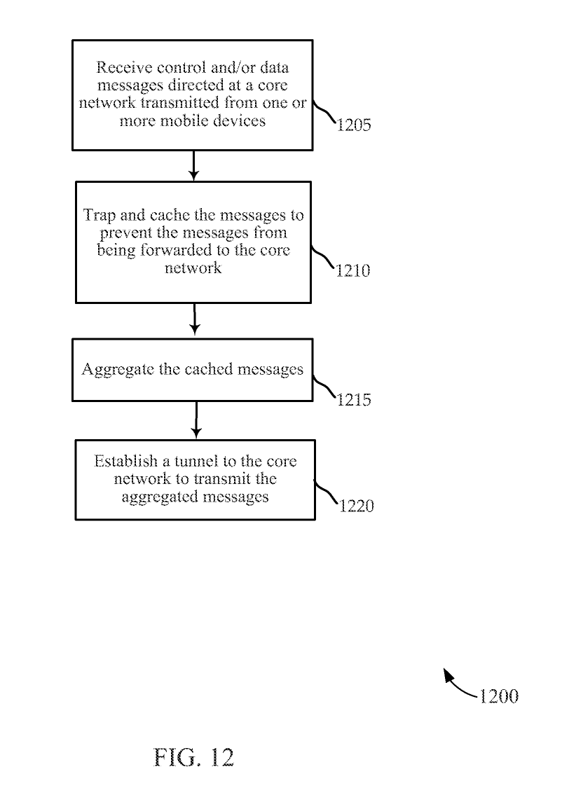

FIG. 12 is a flowchart 1200 of a method for reducing signaling by aggregating messages to the core network of a wireless communications system according to various embodiments of the invention. The method 1200 may be an example of the method 900A of FIG. 9A or method 900B of FIG. 9B. The method 1200 may be performed, for example, in whole or in part, by the proxy module 110 of FIG. 1 or 4, the proxy device 500 of FIG. 5, or the proxy system 600 of FIG. 6. The method 1200 may performed by a BTS 205 or BSC 215 of FIG. 2, a NodeB 305 or RNC 310 of FIG. 3, the eNodeB of FIG. 4, or any combination thereof.

At block 1205, control and/or data messages transmitted from one or more mobile devices and directed at a core network are received. At block 1210, the messages are trapped and cached to prevent the messages from being forwarded to the core network. At block 1215, the cached messages are aggregated. At block 1220, a tunnel to the core network is established to transmit aggregated messages.

### Considerations Regarding the Description

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can be read-only memory (ROM), random access memory (RAM), magnetic RAM, core memory, optical storage mediums or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of message generation, the method comprising:
receiving a request message transmitted from a mobile device and directed at a core network;
trapping the request message to prevent the request message from being forwarded to the core network;
generating a request accept message in response to the trapped request message, the request accept message spoofing a core network response to the request message; and
transmitting the request accept message to the mobile device.

2. The method of claim 1, further comprising:
trapping a core network-initiated message directed at the mobile device, the trapping to prevent the core network-initiated message from being forwarded to the mobile device; and
generating a response message to the trapped core network-initiated message, the response message spoofing the mobile device response to the core network-initiated message.

3. The method of claim 1, wherein,
the request message comprises a context deactivation request message; and
the request accept message comprises a context deactivation accept message, wherein the context remains active in the core network and deactivated at the mobile device.

4. The method of claim 3, further comprising,
receiving a context reactivation request message transmitted from the mobile device;
trapping the context reactivation to prevent the context reactivation message from being forwarded to the core network; and
generating a context reactivation accept message in response to the trapped context reactivation request message, the context reactivation accept message spoofing a core network response to the context reactivation request message.

5. The method of claim 3, further comprising,
receiving a message from the core network directed to the mobile device; and
trapping the message from the core network to prevent the message from the core network from being forwarded to the mobile device.

6. The method of claim 5, further comprising,
paging the mobile device to wake up for context reactivation;
generating a context reactivation message;
transmitting the context reactivation message to the mobile device; and
transmitting the message from the core network to the mobile device.

7. The method of claim 6, wherein,
radio access bearers allocated to the mobile device are taken down when the context is deactivated at the mobile device; and
radio access bearers are set up when the context is reactivated at the mobile device.

8. The method of claim 1, wherein,
the request message comprises a context reactivation request message; and
the request accept message comprises a context reactivation accept message, wherein the context remains active in the core network.

9. The method of claim 1, wherein,
the request message comprises an authentication message; and
the request accept message comprises an authentication verification message.

10. The method of claim 1, wherein the method is performed at least in part by a network node comprising a femtocell, an eNodeB, a radio network controller, or an access service network gateway.

11. The method of claim 10, further comprising:
performing a handoff from a first base transceiver station served by a first network node to a second base transceiver station served by a second network node;
transmitting information related to the handoff to the core network; and
transferring a core network proxy session from the first network node to the second network node.

12. The method of claim 11, wherein the network node comprises the first base transceiver station or second base transceiver station.

13. The method of claim 1, further comprising;
receiving a plurality of additional control messages directed at the core network transmitted from other mobile devices;
trapping and caching the plurality of additional control messages to prevent, at least temporarily, the plurality of additional control messages from being forwarded to the core network; and
aggregating the request message and the plurality of additional control messages for transmission to the core network.

14. The method of claim 1, further comprising;
receiving a plurality of additional control messages directed at the core network transmitted from the mobile device;
trapping and caching the plurality of additional control messages to prevent, at least temporarily, the plurality of additional control messages from being forwarded to the core network; and
aggregating the request message and the plurality of additional control messages for transmission to the core network.

15. The method of claim 1, further comprising;
receiving a plurality of data messages directed at the core network transmitted from the mobile device and other mobile devices;
trapping and caching the plurality of data messages to prevent, at least temporarily, the plurality of data messages from being forwarded to the core network; and
aggregating the plurality of data messages for transmission to the core network, while permanently preventing the request message from the mobile device from being forwarded to the core network.

16. The method of claim 15, wherein the aggregation of data messages is performed with respect to data sessions that are equal or similar in terms of quality-of-service requirements.

17. The method of claim 1, further comprising;
receiving a plurality of data messages directed at the core network transmitted from the mobile device;
trapping and caching the plurality of data messages to prevent, at least temporarily, the plurality of data messages from being forwarded to the core network; and
aggregating the plurality of additional data messages for transmission to the core network, while permanently preventing the request message from being forwarded to the core network.

18. The method of claim 17, wherein the aggregation of data messages is performed with respect to data sessions that are equal or similar in terms of quality-of-service requirements.

19. The method of claim 1, further comprising:
monitoring an amount of core network signaling;
identifying when the monitored amount exceeds a threshold; and
trapping the request message only when the monitored amount exceeds a threshold.

20. The method of claim 1, further comprising:
monitoring an amount of core network signaling being initiated by the mobile device;
identifying when the monitored amount exceeds a threshold; and
trapping the request message only when the monitored amount exceeds a threshold.

21. The method of claim 1, wherein the method is performed by a radio network controller.

22. The method of claim 1, wherein the method is performed by an access service network gateway.

23. The method of claim 1, wherein,
the core network comprises a Packet Data Network Gateway (PGW) and a Serving Gateway (SGW);
the mobile device comprises user equipment (UE); and
the method is performed by an eNode B.

24. The method of claim 1, wherein the method is performed by a femtocell.

25. The method of claim 1, further comprising:
performing a handoff from a first base transceiver station to a second base transceiver station; and
temporarily withholding signaling related to the handoff from the core network.

26. A device for message generation, the device comprising:
means for receiving a request message directed at a core network transmitted from a mobile device;
means for trapping the request message to prevent the request message from being forwarded to the core network;
means for generating a request accept message in response to the trapped request message; and
means for transmitting the request accept message to the mobile device.

27. A proxy device for a wireless network, the proxy device comprising:
a receiver module configured to receive a request message directed at a core network transmitted from a mobile device;
a capture module, communicatively coupled with the receiver module, and configured to trap the request message to prevent the request message from being forwarded to the core network;
a message generation module, communicatively coupled with the capture module, and configured to generate a request accept message spoofing a core network response to the request message; and
a transmitter module, communicatively coupled with the message generation module, and configured to transmit the request accept message to the mobile device.

28. The proxy device of claim 27, wherein,
the capture module is further configured to trap a core network-initiated message directed at the mobile device, the trapping to prevent the core network-initiated message from being forwarded to the mobile device; and
the message generation module is further configured to generate a response message to the trapped core network-initiated message, the response message spoofing the mobile device response to the core network-initiated message.

29. The proxy device of claim 27, wherein,
the request message comprises a context deactivation request message; and
the request accept message comprises a context deactivation accept message, wherein the context remains active in the core network and deactivated at the mobile device.

30. The proxy device of claim 29, wherein,
the receiver module is further configured to receive a context reactivation request message transmitted from the mobile device;
the capture module is further configured to trap the context reactivation to prevent the context reactivation message from being forwarded to the core network; and
the message generation module is further configured to generate a context reactivation accept message in response to the trapped context reactivation request message, the context reactivation accept message spoofing a core network response to the context reactivation request message.

31. The proxy device of claim 29, wherein,
the receiver module is further configured to receive a message from the core network directed to the mobile device; and
the capture module is further configured to trap the message from the core network to prevent the message from the core network from being forwarded to the mobile device.

32. The proxy device of claim 31, further comprising:
a paging module, communicatively coupled with the capture module, and configured to page the mobile device to wake up for context reactivation, wherein,
the message generation module is further configured to generate a context reactivation message in response to the trapped message from the core network; and
the transmitter module is further configured to:
transmit the context reactivation message to the mobile device; and
transmit the message from the core network to the mobile device.

33. The proxy device of claim 32, wherein,
radio access bearers allocated to the mobile device are taken down when the context is deactivated at the mobile device; and
radio access bearers are set up when the context is reactivated at the mobile device.

34. The proxy device of claim 27, wherein,
the request message comprises a context reactivation request message; and
the request accept message comprises a context reactivation accept message, wherein the context remains active in the core network.

35. The proxy device of claim 27, wherein,
the request message comprises an authentication message; and
the request accept message comprises an authentication verification message.

36. The proxy device of claim 27, further comprising:
a handoff module, communicatively coupled with the transmitter module, and configured to perform a handoff from a first base transceiver station to a second base transceiver station, wherein signaling related to the handoff is, at least temporarily, withheld from the core network.

37. The proxy device of claim 27, wherein,
the receiver module is further configured to receive a plurality of additional control messages directed at the core network transmitted from other mobile devices;
the capture module is further configured to trap and cache the plurality of additional control messages to prevent, at least temporarily, the plurality of additional control messages from being forwarded to the core network; and
the message generation module is further configured to aggregate the request message and the plurality of additional control messages for transmission to the core network.

38. The proxy device of claim 27, wherein,
the receiver module is further configured to receive a plurality of additional control messages directed at the core network transmitted from the mobile device;
the capture module is further configured to trap and cache the plurality of additional control messages to prevent, at least temporarily, the plurality of additional control messages from being forwarded to the core network; and
the message generation module is further configured to aggregate the request message and the plurality of additional control messages for transmission to the core network.

39. The proxy device of claim 27, wherein,
the receiver module is further configured to receive a plurality of data messages directed at the core network transmitted from the mobile device and other mobile devices;
the capture module is further configured to trap and cache the plurality of data messages to prevent, at least temporarily, the plurality of data messages from being forwarded to the core network; and
the message generation module is further configured to aggregate the plurality of data messages for transmission to the core network, while permanently preventing the request message from the mobile device from being forwarded to the core network.

40. The proxy device of claim 27, further comprising:
a monitoring module, communicatively coupled with the capture module, and configured to:
monitor an amount of core network signaling;
identify when the monitored amount exceeds a threshold; and
control the capture module to trap the request message only when the monitored amount exceeds a threshold.

41. The proxy device of claim 27, further comprising:
a monitoring module, communicatively coupled with the capture module, and configured to:
monitoring an amount of core network signaling being initiated by the mobile device;
identify when the monitored amount exceeds a threshold; and
control the capture module to trap the request message only when the monitored amount exceeds a threshold.

42. The proxy device of claim 27, wherein the proxy device is a radio network controller or access service network gateway.

43. The proxy device of claim 27, wherein,
the core network comprises a the core network comprises a Packet Data Network Gateway (PGW) and a Serving Gateway (SGW);
the mobile device comprises user equipment (UE); and
the method is performed by an eNodeB.

44. The proxy device of claim 27, wherein the proxy device is a femtocell.

45. A computer program product, comprising:
a computer-readable medium comprising:
code for trapping a request message directed at a core network transmitted from a mobile device to prevent the request message from being forwarded to the core network; and
code for generating a request accept message for transmission to the mobile device in response to the trapped request message, the request accept message spoofing a core network response to the request message.

46. A processor configured to:
receive a request message directed at a core network transmitted from a mobile device;
trap the request message to prevent the request message from being forwarded to the core network;
generate a request accept message spoofing a core network response to the request message; and
transmit the request accept message to the mobile device.

47. A signaling system for a wireless network, the system comprising:
a mobile device configured to transmit a request message directed at a core network; and
a proxy module, in communication with the mobile device and the core network, and configured to:
trap the request message to prevent the request message from being forwarded to the core network;
generate a request accept message in response to the trapped request message; and
transmit the request accept message to the mobile device.

48. The signaling system of claim 47, further comprising:
a core network, in communication with the proxy module, configured to generate a core network-initiated message directed at the mobile device, wherein,
the proxy module is configured to:
trap and cache the core network-initiated message to prevent it from being forwarded to the mobile device;
transmit reactivation messages to the mobile device; and
transmit the cached core network-initiated message when the mobile device is reactivated.

49. The signaling system of claim 48, wherein,
the proxy module comprises a radio network controller or an eNodeB; and
the core network comprises a Packet Data Network Gateway (PGW) and a Serving Gateway (SGW).
